(19) United States
(12) Patent Application Publication
(10) Pub. No.: US 2014/0167686 A1
(43) Pub. Date: Jun. 19, 2014

(54) CONTENT DOWNLOAD AND SYNCHRONIZATION

(71) Applicant: elngot LLC, Great Falls, VA (US)

(72) Inventor: William J. Raduchel, Palo Alto, CA (US)

(21) Appl. No.: 14/133,185

(22) Filed: Dec. 18, 2013

Related U.S. Application Data
(60) Provisional application No. 61/738,615, filed on Dec. 18, 2012.

(51) Int. Cl. H04L 29/08; H02J 7/00

(52) U.S. Cl. CPC H04L 67/1095; H02J 7/0052
USPC 320/107; 320/137

(57) ABSTRACT

Methods, systems, and apparatus for a network-enabled power charging device comprising a processor and a computer readable medium coupled to the processor having instructions stored thereon which, if executed by the processor, cause the network enabled power charging device to perform operations comprising charging, using the network-enabled power charging device, an energy storage component of a user device, determining, by the network-enabled power charging device, a profile associated with the user device, accessing, by the network-enabled power charging device and based on determining the profile associated with the user device, content specified by the profile associated with the user device, loading, using a network interface, the specified content, and enabling, by the network-enabled power charging device, the user device to access the specified content.

### BACKGROUND

Users having user devices, such as mobile telephones or computing devices, implement a variety of techniques for obtaining new content on the user devices. In some instances, a user may regularly obtain content that is updated or revised, or may obtain content that has new installments that are released or made available on a regular basis. The content may be text, graphics, pictures, video, audio, gaming or other, and part of the user experience of obtaining and consuming such content may be the ability to quickly navigate within the content. Users may desire to obtain the content in a way that comfortably fits the user's routine, for example, by downloading the content onto the device in a way that most comfortably fits the user's routine, while not requiring the user to wait as incremental portions of the content are downloaded. Consumers increasingly no longer tether these devices to a computer or other computing device to obtain new content, with the computer or other computing device providing an alternate method for accomplishing this.

### SUMMARY

A network-enabled power charging device may include a profile identifying specific content associated with a user device. In some instances, the network-enabled power charging device may access and/or obtain content specified by the profile and may store the content. When the network-enabled power charging device detects an authorized connection to a user device for which it has an associated profile, the network-enabled power charging device may transmit the content data to the user device, where the content data may then be stored by the user device and/or be presented to the user at the user device. According to some implementations, the network-enabled power charging device may be connected to a power source, and, while connected to the user device, may additionally power the user device or may charge an energy storage unit associated with the user device.

The network-enabled power charging device may be configured through a network connection from a computer or another device, through a built-in web server, by means of software installed on the connected device, by means of a memory card or by any similar mechanism. This configuration may establish a profile associated with a user device on the network-enabled power charging device, the profile determining content for the particular user device to access and the profile authenticating the user device to be eligible to receive the content. The network-enabled power charging device may automatically detect and save identifying attributes associated with any connected user device.

According to some implementations, the network-enabled power charging device may contain one or more unique profiles associated with one or more user devices and may be capable of determining a specific user device and the user device's unique profile. Based on determining a connection to a specific user device associated with a unique profile, the network-enabled power charging device may be capable of transmitting content specified by the unique profile to the user device, and of not transmitting to the user device content not specified by the unique profile associated with the specific user device.

In some instances, the specified content may have one or more associated versions, episodes, or installments, where new versions, episodes, or installments of the content may be released periodically or on a regular basis. In these instances, the network-enabled power charging device may automatically obtain and store new versions, episodes, or installments of the content, and may transmit the new versions, episodes, or installments to a user device whose profile is associated with the content while the user device is connected to the network-enabled power charging device.

According to an innovative aspect of the subject matter described in this specification, a network-enabled power charging device may comprise a processor and a computer-readable medium coupled to the processor having instructions stored thereon which, if executed by the processor, cause the network-enabled power charging device to perform operations comprising charging an energy storage component of a user device, determining a profile associated with the user device, accessing content specified by the profile associated with the user device, loading the specified content, and enabling the user device to access the specified content.

Other embodiments of these aspects include corresponding methods, systems, and computer programs configured to perform the operations of the network-enabled power charging device, encoded on computer storage devices.

These and other implementations can each optionally include one or more of the following features. For instance, the network-enabled power charging device includes charging an energy storage component of a user device and enabling the user device to access the specified content to occur simultaneously, the network-enabled power charging device includes charging an energy storage component of a user device in response to the user device being coupled to the network-enabled charging device, the network-enabled power charging device includes determining specific content associated with the user device, the network-enabled power charging device includes loading the specified content by downloading the specified content from a network, the network-enabled power charging device includes accessing the specified content in response to the user device being coupled to the network-enabled power charging device, the network-enabled power charging device includes accessing the specified content in response to the user device not being coupled to the network-enabled power charging device, the network-enabled power charging device includes accessing the specified content at regular intervals, the network-enabled power charging device includes accessing the specified content based on detecting, by the network-enabled power charging device, that additional specified content is available, and the network-enabled power charging device includes determining a device state associated with the network-enabled power charging device and outputting an indication of the device state.

By transferring content data to a user device while the user device is connected to a network-enabled power charging device, a system, according to one or more implementations described herein, may enhance a user's experience by, for example, reducing the need of the user to manually initialize content transfer to the user device or to remember to transfer new content. According to one or more implementations described herein, the system can enhance a user's experience by reducing the use of data transfer bandwidth while the user is actively using the device. The use of network bandwidth to transfer content data to a user device can inconvenience a user when such transfers occur simultaneously with user attempts to access or transfer other data, as reduction in bandwidth can slow the access or transferring of specific data. Additionally, the system of some implementations can provide an alternative method for the transfer of data to a user device that may not require the user to utilize a portion of a data transfer allowance associated with a user device. For example, if a user device is allotted an allowance of data to be transferred per a period of time, the system of some implementations may enable a user to avoid utilizing a portion of the data allowance by obtaining the data from a network other than the network associated with the data allowance. By transferring content data to a user device while the battery of the user device is charging, the system can enhance a user's experience by enabling a user device to operate for a longer period of time in comparison to instances in which the same content data is transferred to the user device while it is not charging, for a given amount of charge stored on the energy storage device associated with the user device.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1 illustrates an overview of example implementations of the system described herein;

FIG. 2 illustrates example functional components of a system according to one or more implementations described herein;

FIG. 3 illustrates an example of interactions between functional components of the system according to one or more implementations described herein;

FIG. 4 illustrates a flow diagram of an example process for obtaining and updating content, according to one or more example implementations described herein; and

FIG. 5 illustrates a flow diagram of an example process for updating and transferring content according to one or more example implementations described herein.

Like reference numbers and designations in the various drawings indicate like elements.

### DETAILED DESCRIPTION

A system and method, described herein, may enable one or more user devices to obtain content data from a support device. A support device may be a network-enabled power charging device configured to store one or more profiles specific to one or more particular user devices, where a profile may contain information that describes specific content or sets of content that should be transmitted to a particular user device. For example, the content may be content relating to a newspaper issued on a regular basis, an online magazine, or any other content. Based on information specified by the one or more profiles associated with one or more user devices, the support device can obtain content specified by the one or more profiles, for example, by downloading the content through a network.

According to some implementations, the network-enabled power charging device may be a power supply or power adapter device that is capable of powering one or more devices and/or of charging an energy storage component of one or more mobile devices, for example, devices equipped with rechargeable batteries. The network-enabled power charging device may, while powering and/or charging the one or more devices, transmit content data specific to the one or more user devices based on a profile associated with each user device. In some instances, the network-enabled power charging device may additionally feature one or more light-emitting diodes and/or other form of indicator that is capable of indicating a current state of the network-enabled power charging device and/or of providing notifications that may be useful to a user of a user device that is associated with the network-enabled power charging device. For example, one or more indicators may produce a specific output to signify that the network-enabled power charging device is charging or powering a user device, that the network-enabled power charging device is transmitting content to a user device, that the network-enabled power charging device is downloading content, that the network-enabled power charging device has new content that is ready to be transmitted to a profiled user device, or may produce any other specific output to indicate any other relevant status or notification.

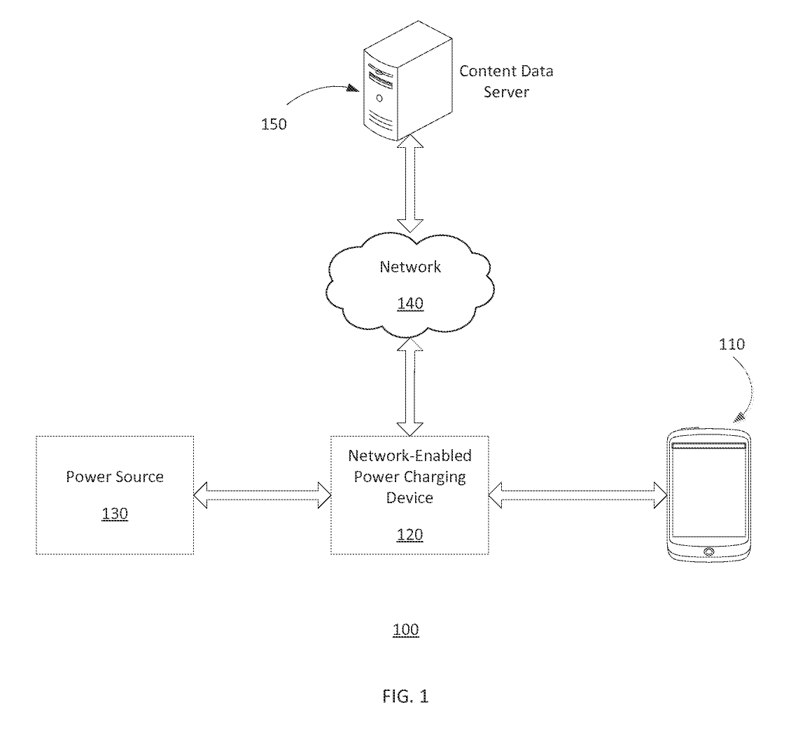

FIG. 1 illustrates an overview of an example implementation of the system described herein. As shown in FIG. 1, the system 100 comprises a user device 110, a network-enabled power charging device 120, a power source 130, a network 140, and a content data server 150. According to some implementations, network 140 facilitates communications between the network-enabled power charging device 120 and the content data server 150. Additionally, according to some implementations, the power source 130 facilitates the powering and/or charging of a user device 110 associated with the network-enabled power charging device 120.

The network 140 is configured to enable the exchange of electronic communications between devices connected to the network 140. For example, the network 140 may be configured to enable the exchange of electronic communications between the network-enabled power charging device 120 and the content data server 150. To enable the exchange of electronic communications, the network 140 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 140 may include multiple networks or subnetworks, each of which may include, for example, a wired or wireless data pathway. The network 140 may include a circuit-switched network, a packet-switched data network, or any other network able to carry electronic communications, e.g., data, voice, and/or video communications. For example, the network 140 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice and/or video protocols used for voice communications. The network 140 may include one or more networks that include wireless data channels and wireless voice and/or video channels. The network 140 may be a wireless network, a broadband network, or a combination of networks including a combination of a wireless network and a broadband network.

User device 110 may be one or more devices that are capable of being powered and of communicating with another device, such as network-enabled power charging device 120. According to some implementations, a user device 110 may be a computing device or mobile computing device. A computing device may be any of the various forms of computing devices, such as a laptop, a desktop, a workstation, a server, a blade server, a mainframe, or other appropriate computer. A mobile computing device may be any of the various forms of mobile computing devices, such as a cellular phone or non-cellular locally networked device, a smart phone, a tablet personal computer, a personal digital assistant, an electronic reader, or other portable computing device that may be utilized for any of communication, gaming, data storage, data organization, content display, or other appropriate mobile computing device. According to some implementations, a user device 110 that is a computing device may be capable of sending and receiving content data, and may be capable of storing content data, for example to a device memory or mass storage unit.

According to some implementations, a user device 110 may be a device other than a computing device or mobile computing device, such as an appliance, machine, or other powered system. For example, a user device 110 may be a device requiring power from a power source to function, and may be a device capable of being identified by a computing device. The user device 110 may be an input/output device, other peripheral device, or other appliance and/or machine. For example, a user device 110 may be any input/output device, e.g., a mouse, monitor, speakers, microphone, wired or remote controller, etc., appliance or other machine, e.g., a refrigerator, thermostat, microwave oven, furnace, air conditioning unit, etc., or any other device that may be powered and/or charged through a support device such as network-enabled power charging device 120, that may send or receive data, and that may store data, for example to a memory or mass storage unit.

According to some implementations, the one or more user devices 110 may exchange electronic communications with network-enabled power charging device 120 through one or more wired or wireless connections. For example, user device 110 may communicate with a network-enabled power charging device 120 using various wired protocols such as Ethernet, Universal Serial Bus (USB), HomePlug (Ethernet over powerline), or other powerline network protocol, or using various local wireless protocols, such as WiFi, Bluetooth, Z-Wave, ZigBee, or any other wired or wireless connection. Although user device 110 is illustrated in FIG. 1 as communicating directly with network-enabled power charging device 120, in some implementations, communications between device 110 and network-enabled power charging device 120 may occur through another method, such as by using network 140.

The user device 110 may be equipped with a memory, where the memory stores information on the user device 110. In some implementations, the memory includes a volatile memory unit or units. In some implementations, the memory includes a non-volatile memory unit or units. The memory may also be another form of computer-readable medium, such as a magnetic or optical disk. A computer-readable medium may be defined as a non-transitory memory device. A memory device may include space within a single physical memory device or spread across multiple physical memory devices.

The user device 110 may be capable of providing mass storage. In some implementations, a mass storage unit may be or may contain a computer-readable medium, such as a floppy disk unit, a hard disk unit, an optical disk unit, or a tape unit, a flash memory or other similar solid state memory unit, or an array of units, including units in a storage area network or other configurations. A computer program product or content data can be tangibly embodied in an information carrier. The computer program product or content data may also contain instructions or data that, when executed, perform one or more methods such as those described herein, or result in the output of the content, for example, at a user device 110. The information carrier is a computer or machine-readable medium, such as a memory, mass storage unit, or memory on processor.

Power source 130 may be any power source capable of powering a network-enabled power charging device 120. According to some implementations, power source 130 may be an alternating current (AC) power source, such as an alternating current power source that allows electrically operated devices to be connected to a primary alternating current power supply, for example, at an electrical wall outlet in a building or through any other connection. Power source 130 may supply power from any generator of electricity or electricity provider, including, for example, an electricity utility network, combustion engine generator, battery, solar cell, turbine generator, or any other method, source, or mechanism capable of supplying electrical power. According to some implementations, power supplied by power source 130 may use a power output standard, such as a voltage, current, or frequency standard. For example, power source 130 may utilize a North American standard by providing power at 110 Volts and 60 Hertz, may utilize a European standard by providing power at 210 Volts and 50 Hertz, or may use any other standard. Additionally or alternatively, power source 130 may supply power at an outlet, such as a wall outlet in a building, and may use an outlet and/or plug standard. For example, power source 130 may provide power using a plug standardized by the National Electrical Manufacturers Association (NEMA) in the United States, the CEE as used in some European countries, or any other standard or combination of standards, or may alternatively not use a standardized connection. In some instances, power source 130 may be a direct current (DC) power source, the direct current power source providing power to the system, for example, to the network-enabled power charging device 120.

Content data server 150, accessed through network 140, is a data server configured to provide content data to a network-enabled power charging device 120, such as content data specified by the one or more profiles associated with one or more user devices 110. Content data can include, for example, an application, a document including text, an audio file, a video file, an image, or combinations of them, for example, a web page, an electronic book (e-book), or electronic magazine (e-magazine). Additionally or alternatively, content data can also include data pertaining to the operation of a device, such as user device 110, or network-enabled power charging device 120, and may include, for example, device settings, user settings, schedules of device settings or user settings (e.g., a schedule for performing a backup process, for setting device notification volumes to specific volume levels, etc.), or any other data relating to the operation of a user device 110 or network-enabled power charging device 120. In some implementations, the content data server 150 can access the content data from one or more server systems (not shown) that are connected to the content data server 150 and that store the content data. Alternatively or in addition, the server system 150 can include a computer-readable storage medium (not shown) that can store the content data on the server system 150.

Network-enabled power charging device 120 is configured to obtain content data, to enable a device 110 to access the content data, and to power or charge one or more user devices 110. Network-enabled power charging device 120 may, in some implementations, operate as a power adapter or power transformer for one or more user devices 110. Additionally, network-enabled power charging device 120 may transmit and/or receive content data, for example, with one or more user devices 110 and/or with a content data server 150 through a network 140. In some instances, network enabled power device 120 may power one or more user devices 110 using power from power source 130, or may supply power from another power source, for example, a battery included as a component of network-enabled power charging device 120.

According to some implementations, network-enabled power charging device 120 may be capable of interfacing with one or more device 110 in order to perform operations comprising electronic communications of content data and powering and/or charging user device 110. In some instances, interfacing network-enabled power charging device 120 with one or more user devices 110 may be achieved using one or more wired or wireless connections and/or methods. For example, the electronic communication of content data between a network-enabled power charging device 120 and one or more user devices 110 may use various wired protocols such as Ethernet, Universal Serial Bus (USB), HomePlug (Ethernet over powerline), or other powerline network protocol, or using various local wireless protocols, such as WiFi, Bluetooth, Z-Wave, ZigBee, or any other wired or wireless connection. Additionally or alternatively, electronic communications of data between a network-enabled power charging device 120 and one or more user devices 110 may use a network, such as network 140. Powering of a user device 110 and/or charging of an energy storage component of a device 110 may use any method of wired or wireless energy transfer, for example, one or more power cables, coaxial cables, USB connections, inductive charging, resonant inductive coupling, or any other method of energy transfer. In some instances, a single interface between a network-enabled power charging device 120 and a user device 110 may enable both electronic communication and powering and/or charging, for example, a powerline network connection (e.g., HomePlug), or a USB connection.

Network-enabled power charging device 120 may be powered by interfacing with a power source 130, for example, using one or more wired or wireless connections. According to some implementations, one or more wired connections may include a power cable connection, for example, a connection at an electrical outlet using one or more standard plug connectors and/or one or more power standards, as described, or may use any other wired power connection. According to some implementations, one or more wireless connections may include an inductive powering or resonant inductive coupling method, or any other wireless power connection. Network-enabled power charging device 120 may be permanently or temporarily connected to a power source 130 where, for example, a temporary connection would allow a network-enabled power charging device 120 to interface with more than one power source 130 (e.g., power sources in different locations, power sources in different locations with a building, etc.).

Network-enabled power charging device 120 may be capable of accessing content data associated with content data server 150. In some instances, a network-enabled power charging device 120 may access content data through one or more networks, such as network 140. According to some examples, a network-enabled power charging device 120 may access content data through one or more networks such as network 140 using one or more wired or wireless connections. For example, network-enabled power charging device 120 may communicate with content data server 150 over network 140 using various wired protocols such as Ethernet, Universal Serial Bus (USB), HomePlug (Ethernet over powerline), or other powerline network protocol, various wireless protocols, such as WiFi, Bluetooth, Z-Wave, ZigBee, connections through various radio, television, internet, mobile, or other networks, or any other wired or wireless connections, as described.

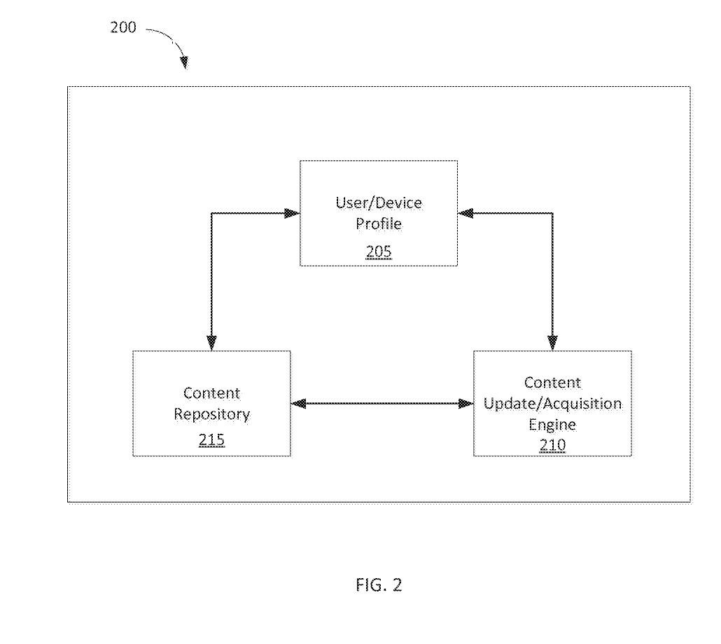

FIG. 2 illustrates example functional components of a system 200, where the system 200 may be a device such as a network-enabled power charging device 120 capable of performing the operations described herein. As shown in FIG. 2, system 200 includes a device profile catalog 205, a content acquisition engine 210, and a content repository 215. According to some implementations of the described subject matter, device profile catalog 205 may include one or more profiles associated with one or more user devices 110. In some instances, content acquisition engine 210 may, based on information contained in device profile catalog 205, access and/or obtain content data, such as content data associated with content data server 150. According to some implementations, content repository 215 may store content data, such as content data accessed and/or obtained by content acquisition engine 210. Additionally or alternatively, content repository 215 may associate content data with one or more device profiles, such as one or more device profiles included in device profile catalog 205.

In practice, a device profile catalog 205 may be associated with a network-enabled power charging device 120 and may be capable of storing data associated with one or more profiles corresponding to one or more user devices 110. In some implementations, the one or more profiles may be accessed and/or obtained from the one or more user devices 110, for example, when the one or more user devices 110 are connected to a network-enabled power charging device 120 through one or more wired or wireless connections. Additionally or alternatively, device profile catalog 205 may access and/or obtain data associated with one or more profiles corresponding to one or more user devices 110 through a network, for example, network 140. Device profile catalog 205 may store data associated with the one or more profiles, for example, using a memory or mass storage unit associated with a network-enabled power charging device 120. In some instances of system 200, data identifying the one or more profiles may be obtained every time a user device 110 is connected to the network-enabled power charging device 120, may be obtained and stored during a first connection between a user device 110 and a network-enabled power charging device 120, may be periodically obtained when a user device 110 and a network-enabled power charging device 120 are connected, or may be obtained and/or stored based on any other triggering event between a user device 110 and a network-enabled power charging device 120.

Data associated with one or more profiles corresponding to one or more user devices 110 may include information identifying particular content to associate with the one or more user devices 110. According to some implementations, information identifying content may include, for example, titles or names associated with the content, subjects of the content, names of individual or groups of people associated with the content, dates related to the content, data sizes associated with the content, and/or other information used to identify particular content associated with a particular user device 110. In practice, the content specified may include, for example, one or more magazines, newspapers, documents containing text, images, audio files, video files, podcasts, or content containing a combination of these, or may additionally or alternatively include one or more device settings, device operating parameters, or other content. In some examples, different versions, episodes, or installments of the content may be released and/or updated. For example, content specified by a profile associated with a particular user device 110 may include one or more magazines, newspapers, or television programs, where the one or more magazines, newspapers, or television programs may release new episodes, versions, or installments, for example, once per day or once per month. In such instances, the information contained within the profile associated with the user device 110 may also indicate that the content is content wherein new versions, episodes, or installments of the content may be released, and may indicate how frequently the content may be released.

Additionally or alternatively, content specified by a profile associated with a particular user device 110 may include one or more maps, such as one or more topographical maps, road maps, trail maps, GPS coordinate information, nautical maps, or other information that may be used for navigation or by navigation services. In such instances, the maps or other navigation information may be updated using similar techniques as described for the updating, accessing, downloading, and storing of content. In some instances, maps or other navigation information may be associated with one or more versions, such that versions of the maps or other navigation information may be released and/or updated. In such instances, the information contained within the profile associated with the user device 110 may also indicate that the maps or other navigation information are maps or navigation information wherein new versions may be released, and may indicate how frequently the new versions may be released.

Additionally or alternatively, content specified by a profile associated with a particular user device 110 may include one or more games, such as one or more web-based games, application-based games, or other games that operate over a network connection and/or locally on the user device 110. In some instances, the games may be associated with one or more versions or instances, such that versions or instances of the games may be released and/or updated. In such instances, the information contained within the profile associated with the user device 110 may also indicate that the games wherein new versions or releases may become available, and may indicate how frequently the new versions or releases may become available.

In some instances, a subset of the content specified by the profile of a particular user device 110 may be content that is also identified by the profile of another user device 110. For example, a profile associated with a user device 110, such as a smartphone device, may specify content that is a newspaper, for example, the Wall Street Journal. In some instances, a profile associated with a second, different user device 110, for example an electronic book reading device (E-reader), may also specify the Wall Street Journal as content associated with the device. In some implementations of system 200, the device profile catalog 205 may determine that the profile associated with the smartphone device and the profile associated with the electronic book reader device refer to at least some of the same content.

Implementations of a device profile catalog 205 may utilize any number of data formats to catalog and/or store data associated with profiles corresponding to one or more user devices 110. For example, data associated with one or more profiles may be stored using a tabular format, for example, a table using rows and columns. Additionally or alternatively, data structures to catalog and/or store one or more profiles may include one or more linked lists, binary search trees, hash tables, arrays, and/or any other type of data structure.

Based on content specified by one or more profiles associated with one or more user devices 110 in device profile catalog 205, content acquisition engine 210 may access and/or obtain content data associated with the one or more profiles. To access and/or obtain content data associated with the one or more profiles, content acquisition engine 210 may access information contained in device profile catalog 205 to determine the content data to access and/or store.

Based on information from device profile catalog 205, content acquisition engine 210 may identify specific content data. Content acquisition engine 210 may identify specific content data by accessing a content data server, such as content data server 150, through a network such as network 140 that enables electronic communications between a network-enabled power charging device 120 and a content data server 150. Based on identifying content data associated with one or more profiles corresponding to one or more user devices 110, content acquisition engine 210 may access and/or obtain the identified content data. For example, content acquisition engine 210 may access the identified content data associated with content data server 150, and may additionally or alternatively obtain the identified content data, for example, by downloading the identified content from content data server 150. Accessing and/or obtaining the identified content data may comprise accessing and/or obtaining the content from a content data server 150, for example, using a network 140.

In some examples, a system 200 that includes a content acquisition engine 210 may associate specific content with one or more profiles that correspond to one or more user devices 110. According to some implementations of the described system, the association of specific content to a particular user device 110 may involve associating the content data with a profile corresponding to the particular user device 110 in a device profile catalog 205. Specific content may be associated with a profile, for example, by creating a pointer to the specific content data and associating the pointer with the profile, storing the content data or a copy of the content data within the profile, or by any other method.

According to some implementations, content acquisition engine 210 may determine that one or more profiles associated with one or more user devices 110 contained in device profile catalog 205 may specify content that has versions, episodes, or installments that may be regularly or irregularly released and/or updated. For example, content acquisition engine 210 may determine, based on information contained in device profile catalog 205, that content specified by the one or more profiles may be one or more magazines, newspapers, or television programs, where the one or more magazines, newspapers, or television programs may release new episodes, versions, or installments, for example, once per day or once per month. In such instances, content acquisition engine 210 may determine whether to access and/or obtain the content based on specific information related to the episodes, versions, or installments. For example, content acquisition engine 210 may access and/or obtain the content based on a date associated with the most recent episode, version, or installment, the length of time since the most recent episode, version, or installment became available, or based on other information. Additionally or alternatively, content acquisition engine 210 can identify the content, for example, at content data server 150, and can determine if the content should be accessed and/or obtained from the content data server 150 by determining if the one or more profiles specifying the specific content are associated with the most recent version, episode, or installment of the content. For example, the system may determine if a profile that is associated with the Wall Street Journal and corresponding to a particular user device 110 has already obtained the most recent version of the Wall Street Journal.

In some instances, at least a subset of the content identified, accessed and/or obtained by content acquisition engine 210 may be specified by more than one user devices 110. For example, content acquisition engine 210 may, based on information acquired from device profile catalog 205, access and/or obtain a recent version of the Wall Street Journal. According to this example, one or more profiles corresponding to one or more user devices 110 may specify the Wall Street Journal as content associated with that user device. For example, a first profile corresponding to a smartphone device and a second profile corresponding to an electronic book reading device may both indicate that the Wall Street Journal is at least a subset of the content associated with that device. In such instances, the system 200 may, for example, create one or more pointers for each of the one or more user devices 110 associated with the Wall Street Journal and associate the one or more pointers with the content, may store the content or a copy of the content data with the profile associated with both the smartphone and the electronic book reading device, or may associate the content data with the profiles by any other method.

According to some implementations of the subject matter described herein, content data accessed and/or obtained by content acquisition engine 210 may be stored in a content repository 215 associated with a system 200, such as a network-enabled power charging device 120. According to some implementations, content acquisition engine 210 may identify, access, and obtain content data specified by one or more profiles in device profile catalog 205 and corresponding to one or more devices 110. Subsequently, the content may be stored in a content repository 215 and associated with one or more profiles that specify the particular content. According to some implementations of the described subject matter, content data can be stored in content repository 215 using a memory or mass storage unit on a device such as network-enabled power charging device 120. In some cases, a memory may include a volatile memory unit or units or a non-volatile memory unit or units. The memory may also be another form of computer-readable medium, such as a magnetic or optical disk, or may be defined as a non-transitory memory device. In some implementations, the memory device may include space within a single physical memory device or spread across multiple physical memory devices. In some instances, content repository 215 may use a mass storage unit, where the mass storage unit may be or contain a floppy disk unit, a hard disk unit, an optical disk unit, or a tape unit, a flash memory or other similar solid state memory unit, or an array of units, including units in a storage area network or other configurations.

According to some implementations of the described subject matter, device profile catalog 205 may contain one or more profiles corresponding to one or more user devices 110 that specify content associated with the one or more user devices 110. In instances in which content associated with the one or more devices 110 is identified, accessed, and obtained by a content acquisition engine 210 and stored in a content repository 215, the one or more profiles in device profile catalog 205 may be able to associate content maintained in content repository 215 with the appropriate device profiles. For example, profile catalog 205 may be able to identify content data specified by a profile corresponding to a particular user device 110, and may be able to identify and access the specified content data in a content repository 215. The profile catalog 205 may then be capable of associated the specified content with the profile corresponding to the particular user device 110. In some instances, this may be achieved by, for example, creating a pointer in the profile that is associated with the particular content stored in content repository 215, or by any other method that may allow specific content stored in content repository 215 that is specified by one or more profiles to be associated with the one or more profiles.

In some instances, more than one profile may be associated with particular content maintained in content repository 215. In such cases, multiple pointers may be created, for example one pointer for each of the one or more profiles, and associated with the same content, in such a way that multiple versions of the same content are not stored in content repository 215, but that one or more user devices 110 may access and be associated with the same content.

In some instances, a particular content may be content with multiple versions, episodes, or installments and may be content that regularly or irregularly releases or updates the versions, episodes, or installments of the content. For example, content specified by one or more profiles associated with one or more user devices 110 may include magazines, newspapers, or television programs, where the magazines, newspapers, or television programs may release new episodes, versions, or installments, for example, once per day or once per month. In such instances, content acquisition engine 210 may identify, access, and/or obtain content associated with new episodes, versions, or installments of the magazines, newspapers, or television programs. In such instances, content repository 215 may, store the new episodes, versions, or installments of the content as additional content, for example, as additional content data files within content repository 215. Alternatively, content repository 215 may, according to some implementations, replace older episodes, versions, or installments of the content with episodes, versions, or installments of the content determined to be newer episodes, versions, or installments of the content. For example, a data file containing content data of a newer edition of a magazine or newspaper may replace a file stored in content repository 215 associated with a prior edition of the magazine or newspaper. Additionally or alternatively, a file associated with an older episode, version, or installment of the content may be replaced based on the length of time since the content was last released or updated, based on how many versions or episodes of the content have been stored in content repository 215, based on whether the content has been transmitted to the user device 110 associated with the profile specifying the content, or based on any other criteria.

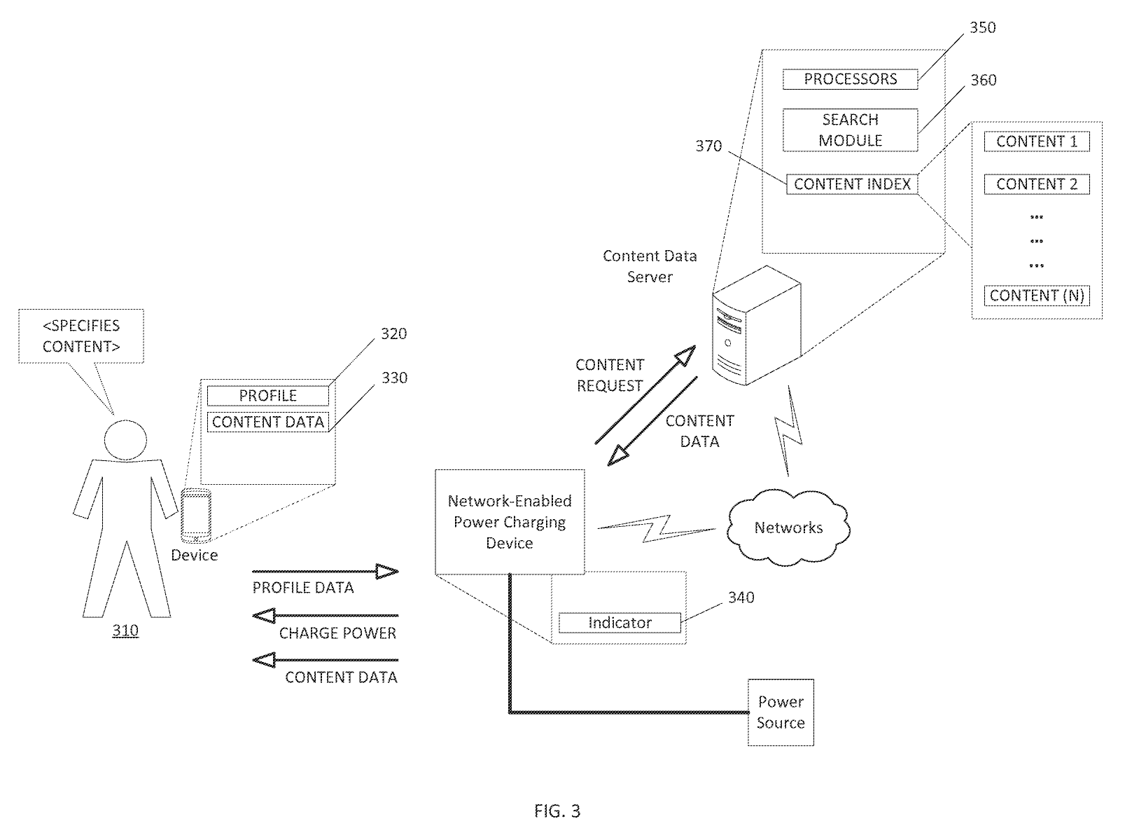

FIG. 3 illustrates example interactions between functional components of the system 300 according to one or more implementations described herein. According to some implementations, system 300 includes a user 310, a user device 110 comprising a profile 320, content data 330, and an indicator 340, a network-enabled power charging device 120, a power source 130, and one or more networks 140 configured to enable access to one or more content data servers 150, where the one or more content data servers 150 comprise at least one or more processors 350, a search module 360, and a content index 370. Using the illustrated connections and interfaces, the components of system 300 are capable of transmitting electronic communications, such as data related to one or more profiles and/or content data. The system 300 may also provide power, such as power from power source 130, to user device 110 to enable powering of user device 110 and/or charging of an energy storage component of user device 110.

According to some implementations of system 300, a user 310 may specify content to associate with a profile of a user device 110 at an interface of user device 110 as shown, or through another method, for example, a web page or at an interface of a network-enabled power charging device 120. Specified content may include multimedia content, for example, a document including text, an audio file, a video file, and image, or combinations of these, for example, a web page, an electronic book (e-book), or an electronic magazine (e-magazine), or may additionally or alternatively include other content, for example, an application, device settings, user settings, schedules of device settings or user settings (e.g., a schedule for performing a backup process, for setting device notification volumes to specific volume levels, etc.), or any other content relating to the operation of a user device 110 or network-enabled power charging device 120.

User device 110 may comprise a profile 320 that identifies specified content associated with the specific user device 110. In practice, this profile may be stored in a physical location on the user device 110 as shown in FIG. 3, such as in a physical memory or mass storage unit that is contained on the user device 110, or may be stored elsewhere, for example, in a memory or storage unit associated with a network-enabled power charging device 120, on a server that is accessible through a network, on a web page, or in any other location.

User device 110 may also comprise content data 330, where content data may be specified content as determined, for example, by a profile 320 corresponding to the user device 110. In some instances, content data 330 may be maintained on user device 110 as shown in FIG. 3, for example in a physical memory or mass storage unit, such as a hard drive, SD card, or other storage unit on the user device 110. In other instances, content data 330 may be stored in any other location in which it is accessible to user device 110, for example, on a server that is accessible by user device 110 through a network, on a web page, or in another location.

According to some implementations, user device 110 may connect to a network-enabled power charging device 120, for example, through one or more network and/or power connections, as described. Through the one or more connections, electronic communications and/or power transfer may be achieved between user device 110 and a network-enabled power charging device 120. For example, user device 110 may be capable of transmitting profile data through the one or more connections to network-enabled power charging device 120. In response to the connection, the network-enabled power charging device 120 may be capable of transmitting content data, such as content data 330, and/or power to user device 110, such as power to power user device 110 and/or charge an energy storage component associated with user device 110.

To achieve the transfer of power from network-enabled power charging device 120 to user device 110, the system of some implementations may utilize a connection between the network-enabled power charging device 120 and a power source 130. This connection may be achieved using a power cable coupling the power source 130 to the network-enabled power charging device 120, for example, at a wall outlet plug connection, or through any other connection, as described.

According to some implementations of system 300, one or more networks such as one or more networks 140 may enable communication between a network-enabled power charging device 120 and one or more content data servers 150. In some instances, communications between a network-enabled power charging device 120 and one or more content data servers 150 may include exchanges of requests for content data or transmission of content data, for example, content data 330. In some instances, based on the content requested and/or received from one or more data servers 150, a network-enabled power charging device 120 may transmit received content data to a user device 110, where one or more user devices 110 may store the transmitted content as content data 330.

According to some implementations, one or more content data servers 150 may comprise one or more processors 350, search modules 360, and/or content indices 370. Processors 350 suitable for the application may include, by way of example, both general and special purpose microprocessors, and any one or more processors of any kind of digital computer capable of receiving instructions in a computer-readable format and performing operations based on the received instructions. Search module 360 may be any search module capable of generating, translating, accepting, providing, and/or otherwise processing a query of a content index 370. For example, search module 360 may be capable of accepting a content request from a network enabled power charging device 120, may generate a query based on the content request, and may search a content index 370 for the content. Search module 360 may search the content index 370 that contains, for example, Content 1 through Content N, and may return, based on the search, one or more content files. According to some implementations, the returned content may then be transmitted to the network-enabled power charging device 120, for example, using one or more networks 140.

In some implementations, network-enabled power charging device 120 may be additionally equipped with one or more indicators, such as indicator 340. For example, a network-enabled power charging device 120 may be equipped with one or more light-emitting diodes (LED) used to provide indications of a state of the network-enabled power charging device 120. In some instances, the one or more indicators may produce a specific output to signify that the network-enabled power charging device 120 is in a particular device state, such as charging or powering a device, transmitting content to a device, downloading content, has new content that is ready to be transmitted to a profiled device, or any other state. In other instances, an indicator 340 may be any other type of indicator, such as a sound indicator, a vibrator indicator, or a display providing an image, symbol, or message, or any other indicator,

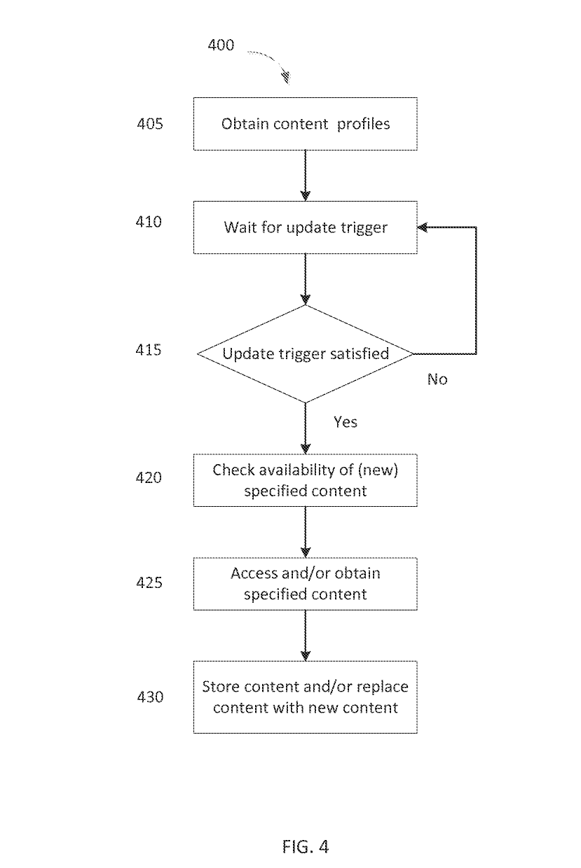

FIG. 4 illustrates a flow diagram for an example process 400 for accessing and obtaining content associated with one or more profiles corresponding to one or more user devices 110. Process 400 includes a series of steps, where the steps may be performed by, for example, a device profile catalog 205, a content acquisition engine 210, and/or a content repository 215, such as those implemented in a network-enabled power charging device 120.

Process 400 begins by identifying one or more profiles stored by the system that correspond to one or more user devices 110. For example, the system may store the one or more profiles corresponding to one or more user devices 110 in a device profile catalog 205 of a network-enabled power charging device 120. In some instances, the identified profiles may specify various content to associate with the one or more user devices 110, where the various content may be particular content related to, for example, one or more magazines, newspapers, images, audio files, video files, documents containing text, or content containing a combination of these, such as in a web page or electronic book, device settings, device operating parameters, or other content.

Prior to step 405, the system of some implementations may have obtained and stored one or more profiles corresponding to one or more user devices 110, where each user device 110 may have at least one corresponding profile. For example, the network-enabled power charging device 120 may have been previously connected to a user device 110, and may have obtained information relating to a profile associated with the user device 110. The system of some implementations may have stored the profile corresponding to the user device 110, for example, in a device profile catalog 205 associated with the network-enabled power charging device 120, or may have stored the profile in another location, such as on a server accessible to the network-enabled power charging device 120.

In some implementations, a user may interact with a user device 110 to indicate particular content to associate with a profile of the user device 110 that can be identified and stored by the system, for example, in a device profile catalog 205 associated with the network-enabled power charging device 120. In some instances, an application with an interface on a user device 110 may enable a user to identify particular content to associate with the profile of a user device 110. Additionally or alternatively, in some instances, a user of a user device 110 may identify particular content to associate with the profile of the user device 110 by accessing an interface through a network, for example, by accessing a webpage on the Internet. Any number of other methods may be used to enable a user to specify content with respect to a profile corresponding to a particular user device 110, for example, by uploading data relating to the content to the user device 110, through a service that enables the updating or specifying of device profiles

At process 410, the system awaits a trigger event to determine that the system should update the content data associated with the one or more profiles corresponding to user devices 110. A triggering event, as described previously with respect to FIG. 2 and according to some implementations of the described subject matter, may include triggering events based on detecting connections between a network-enabled power charging device 120 and a user device 110 or content data server 150, include time-based triggering events, user-defined triggering events, or any other event that can be used to determine that the content associated with the one or more profiles should be updated or downloaded. For example, a triggering event may include detecting a connection between a user device 110 and a network-enabled power charging device 120, or a connection between a network-enabled power charging device 120 and a content data server 150. Additionally or alternatively, a triggering event may be based on an elapsed amount of time or on a particular time of day. For example, a trigger may be identified once every hour, once every day, or based on the time being 6:00 AM on any particular day. In some instances, user-defined events may be utilized as triggering events, for example, events associated with an alarm, events associated with a user opening a particular application on a user device 110 while the device is connected to a network-enabled power charging device 120, or based on any other event.

At process 415, the system determines if a triggering event has been detected. In the case that a triggering event has not been detected, i.e., “NO”, the process 400 returns to step 410, where the process continues to await a trigger. If a triggering event, such as one or more of the triggering events described above, is detected, i.e., “YES”, then the process 400 proceeds to step 420. According to implementations of the described system, the detection of a triggering event may be determined by, for example, a component of a network-enabled power charging device 120, such as the device profile catalog 205, content acquisition engine 210, content repository 215, or other module of the network-enabled power charging device 120, or by any other element of the system described herein, for example, a content data server 150 or a user device 110.

At process 420, the system of some implementations identifies content associated with the one or more profiles corresponding to one or more user devices 110, and determines if new content is available. According to some implementations, content acquisition engine 210 may identify the content associated with the one or more profiles by accessing profile information in device profile catalog 205. Based on the content specified, for example, by the one or more profiles in device profile catalog 205, the content acquisition engine 210 may access a content server such as content data server 150 and identify if the specified content is available. The content acquisition engine 210 may determine if the specified content is available, for example, by querying the content data server 150 for the specified content, or by another method. Additionally or alternatively, if the specified content is a content in which new versions, episodes, or installments are released, the content acquisition engine 210 may determine if recent versions, episodes, or installments of the content are available. In some implementations, content acquisition engine 210 may also access data stored at content repository 215 to determine if the available content is already stored in the content repository 215 of the network-enabled power charging device 120. In some implementations, the content acquisition engine 210 may also access data stored at content repository 215 to determine if recent versions, episodes, or installments of the content are already stored in the content repository 215, and additionally if recent versions, episodes, or installments of the content identified on content data server 150 are more recent than the versions, episodes, or installments stored in the content repository 215. In some instances, the content acquisition engine 210 may only determine if content associated with the profile corresponding to a connected user device 110 is available, and may forego determining if content associated with other profiles corresponding to other, disconnected user devices 110 is available.

At process 425, based on the availability and/or presence of the specified content or of new versions, episodes, or installments of the specified content, the system of some implementations may access and/or obtain the specified content. As described previously with respect to FIG. 2, accessing and/or obtaining the content may involve processes in which the content acquisition engine 210 accesses the specified content on a content data server 150, and/or downloads the specified content data from the content data server 150. As described, accessing and/or downloading the specified content may include accessing and/or downloading the specified content through one or more networks, such as one or more networks 140. In some instances, the system may access and/or obtain a subset of the specified content that is available. For example, the system of some implementations may only access and/or obtain content that is associated with a profile corresponding to a user device 110 that is currently connected to the network-enabled power charging device 120.

At process 430, the system of some implementations may store the accessed and/or obtained content, and/or may replace prior versions, episodes, or installments of the specified content with new versions, episodes, or installments of the specified content. Specified content that has been accessed and/or obtained, for example, by content acquisition engine 210, may be stored in the system, such as in content repository 215 of network-enabled power charging device 120. According to some examples, at the time of storing the specified content, the specified content can additionally be associated with the one or more profiles that specify the content, such as one or more profiles stored in device profile catalog 205 that correspond to one or more user devices 110.

In some instances, the specified content accessed and/or obtained by content acquisition engine 210 may be one or more recent versions, episodes, or installments of a specified content, wherein one or more versions, episodes, or installments of the content are already stored, such as in content repository 215. In such instances, the system of some implementations may store the recently accessed and/or obtained versions, episodes, or installments of the specified content, for example, by storing them to a content repository 215. Additionally, in response to storing the recently accessed and/or obtained versions, episodes, or installments, the system of some implementations may remove or delete prior versions, episodes, or installments of the content, may give priority to the more recent versions, episodes, or installments of the content when providing such content to a device 110, or may otherwise take action on the prior versions, episodes, or installments of the specified content based on more recent versions, episodes, or installments of the content being stored. For example, a system of some implementations may only store a particular number versions, episodes, or installments of specified content and may remove or delete additional prior versions, episodes, or installments in excess of the particular number. According to some implementations, a user of a user device 110 may be capable of identifying preferences relating to the storing of multiple versions, episodes, or installments of specified content.

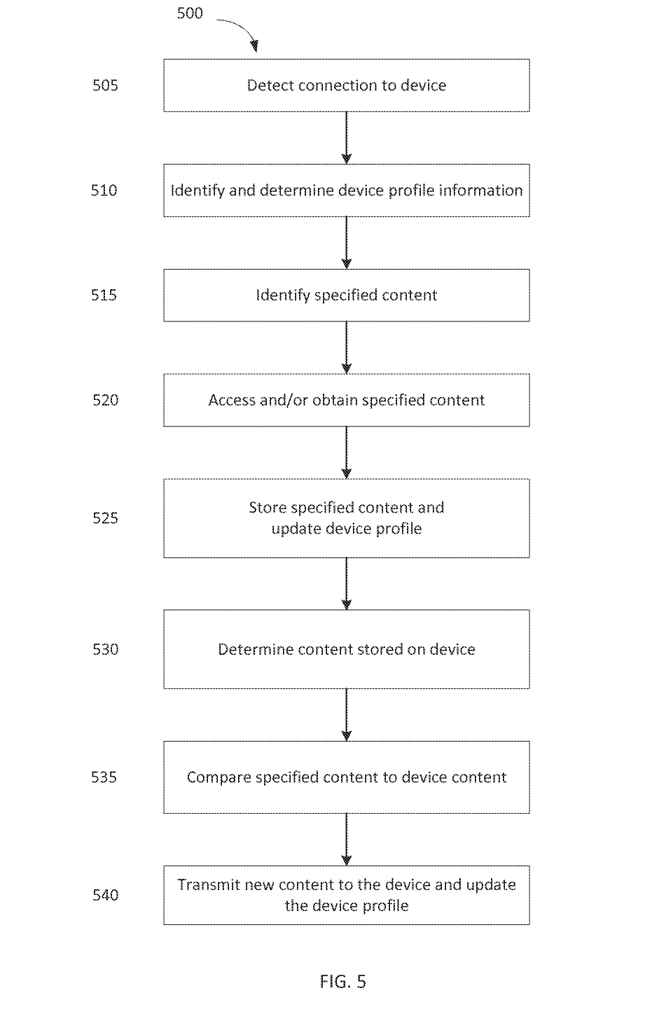

FIG. 5 illustrates a flow diagram pertaining to an example process 500 for updating and transferring content to one or more user devices 110. Process 500 comprises a series of steps, where the steps may be performed by, for example, a device profile catalog 205, content acquisition engine 210, and content repository 215 of a network-enabled power charging device 120.

Process 500 begins at step 505 by detecting the connection of a device, such as a user device 110, to a network-enabled power charging device 120. The connection of a user device 110 and a network-enabled power charging device 120 may occur using any method described, for example, using the one or more methods described in reference to FIG. 4. In response to detecting the connection of a user device 110 to a network-enabled power charging device 120, network-enabled power charging device 120 may also initiate the powering and/or charging of user device 110, for example, using one or more of the methods described in reference to FIG. 1.

At process step 510, the system of some implementations may identify the user device 110 and may determine a profile associated with the user device 110. According to some implementations, the network-enabled power charging device 120, upon detecting a connection to user device 110, may use any method to determine the identity of the user device 110, such as accessing drivers associated with the device, accessing information on a subscriber identity module (SIM) card, or based on any other method. Based on determining the identity of the user device 110, the system of some implementations may attempt to determine a profile associated with the user device 110, for example, by accessing device profile catalog 205 of a network-enabled power charging device 120.

In some instances, a profile associated with user device 110 may already exist and be stored by device profile catalog 205. In such instances, the system of some implementations may access the profile associated with user device 110 in order to determine specified content associated with the user device 110. In some instances, a profile corresponding to a user device 110 may exist and may additionally be updated and stored by the system, for example, in response to determining that changes have been made to the profile since the profile was last accessed by the system. According to some implementations, the profile and any updates to the profile may be determined by the system by accessing profile data corresponding to the user device 110, for example, by accessing profile information stored on the user device 110, on a server, or by any other means. In some instances, the system may determine that it does not contain a stored profile associated with a connected user device 110, and may in response to determining that it does not have a stored profile corresponding to the user device 110, obtain and store a profile using one or more of the methods described in reference to FIG. 4.

At step 515, using profile data corresponding to user device 110, the system of some implementations may identify specified content, for example using content acquisition engine 210. As described with respect to FIG. 4, content may be identified on one or more servers, such as on one or more content data servers 150. In some implementations, content acquisition engine 210 may additionally access content data such as content data stored in content repository 215 to determine specified content that has been previously accessed and stored by the system. In some implementations, content acquisition engine 210 may determine that specified content is content in which versions, episodes, or installments of the content are released, and may access stored content data to determine if the identified content at content data server 150 represents new versions, episodes, or installments of the specified content that are not currently stored by the system.

At step 520 of process 500, in response to identifying specified content and determining specified content that is not stored by the system or is a new version, episode, or installment of the content, the system of some implementations may access and/or obtain the content. According to some implementations, the system may access and/or obtain the content using content acquisition engine 210, as described with respect to process step 425 of FIG. 4.

At process 525, in response to obtaining the specified content at process 520, the system of some implementations may store the content, for example, in content repository 215, and may update or otherwise change information associated with one or more profiles corresponding to user device 110. According to some implementations, the content data may be stored in content repository 215 according to the one or more methods described with respect to FIG. 4. Additionally, according to some implementations, the one or more profiles associated with user devices 110 and contained, for example, in device profile catalog 205, may be adjusted in order to associate the specified content with the one or more profiles. For example, one or more pointers may be created for each profile, wherein the one or more pointers are then associated with the specified content that has been obtained and stored in content repository 215.

According to some implementations, a profile specifying content associated with multiple versions, episodes, or installments, may determine that more recent or different versions, episodes, or installments of the content have been obtained and stored by the system, and that the obtained and stored versions, episodes, or installments should be associated with the profile. In addition, the system may determine that versions, episodes, or installments of the specified content that are prior to the obtained and stored versions, episodes, or installments should be disassociated with the profile, for example, by deleting the files associated with the prior versions, episodes, or installments from content repository 215 or user device 110, or by removing a pointer stored in a profile directed to the file associated with the prior versions, episodes, or installments.

In some instances, the association or disassociation of particular content or particular versions, episodes, or installments of content may be determined based on user preference data associated with the profile corresponding to user device 110. For example, a profile associated with a user device 110 may specify that recently obtained versions, episodes, or installments of the content should replace prior versions, episodes, or installments of the content, that recently obtained versions, episodes, or installments should be associated with the user device 110 in addition to the prior versions, episodes, or installments, that a maximum number of most recently obtained versions, episodes, or installments should remain associated with the device 110 before being disassociated with the user device 110 and/or replaced by more recent versions, episodes, or installments, or may specify any other preference.

At process 530, the system of some implementations may determine content stored on the user device 110. For example, the system of some implementations, in response to the user device 110 being connected to, for example, a network-enabled power charging device 120, may determine content currently stored on the user device 110 by accessing one or more memory or mass storage units associated with user device 110 and identifying files containing content stored therein.

At process 535, the system may compare content obtained and stored by the system to content being stored on the user device 110. For example, at process 535, a device such as a network-enabled power charging device 120 may access a device catalog 205, determine a profile corresponding to a device 110 connected to the network-enabled power charging device 120, and compare the specified content associated with the profile to the content stored on the user device 110. In some instances, the system of some implementations may achieve this by comparing file names, content types, content metadata, or other data identifying the content currently stored on the user device 110, to the content specified by the device profile.

At step 540 of process 500, and based on the comparing of content data stored on the user device 110 and content specified by the profile corresponding to user device 110, specified content not stored on the user device 110 may be transmitted and stored on the user device 110. Additionally or alternatively, content stored on the user device 110 that is not specified by the profile corresponding to the user device 110 may be removed from the storage of the user device 110. According to some implementations, the storing or removing of content may involve storing or deleting files containing the content data, or may be achieved by any other method.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A network-enabled power charging device comprising:
a processor; and
a computer-readable medium coupled to the processor having instructions stored thereon which, if executed by the processor, cause the network-enabled power charging device to perform operations comprising:
charging, using the network-enabled power charging device, an energy storage component of a user device;
determining, by the network-enabled power charging device, a profile associated with the user device;
accessing, by the network-enabled power charging device and based on determining the profile associated with the user device, content specified by the profile associated with the user device;
loading, using a network interface, the specified content; and
enabling, by the network-enabled power charging device, the user device to access the specified content.

2. The system of claim 1, wherein charging an energy storage component of a user device and enabling the user device to access the specified content occur simultaneously.

3. The system of claim 1, wherein charging an energy storage component of a user device comprises charging the energy storage component of the user device in response to the user device being coupled to the network-enabled power charging device.

4. The system of claim 1, wherein determining a profile associated with the user device comprises determining specific content associated with the user device.

5. The system of claim 1, wherein loading content specified by the profile associated with the user device comprises loading the specified content by downloading the specified content from a network.

6. The system of claim 1, wherein accessing content specified by the profile associated with the user device comprises accessing the specified content in response to the user device being coupled to the network-enabled power charging device.

7. The system of claim 1, wherein accessing content specified by the profile associated with the user device comprises accessing the specified content in response to the user device not being coupled to the network-enabled power charging device.

8. The system of claim 1, wherein accessing content specified by the profile associated with the user device comprises accessing the specified content at regular intervals.

9. The system of claim 1, wherein accessing content specified by the profile associated with the user device comprises accessing the specified content based on detecting, by the network-enabled power charging device, that additional specified content is available.

10. The system of claim 1, wherein the operations further comprise:
determining, by the network-enabled power charging device, a device state associated with the network-enabled power charging device; and
outputting, by the network-enabled power charging device, an indication of the device state.

11. A computer-implemented method comprising:
charging, using the network-enabled power charging device, an energy storage component of a user device;
determining, by the network-enabled power charging device, a profile associated with the user device;
accessing, by the network-enabled power charging device and based on determining the profile associated with the user device, content specified by the profile associated with the user device;
loading, using a network interface, the specified content; and
enabling, by the network-enabled power charging device, the user device to access the specified content.

12. The method of claim 11, wherein charging an energy storage component of a user device and enabling the user device to access the specified content occur simultaneously.

13. The method of claim 11, wherein charging an energy storage component of a user device comprises charging the energy storage component of the user device in response to the user device being coupled to the network-enabled power charging device.

14. The method of claim 11, wherein determining a profile associated with the user device comprises determining specific content associated with the user device.

15. The method of claim 11, wherein loading content specified by the profile associated with the user device comprises loading the specified content by downloading the specified content from a network.

16. The method of claim 11, wherein accessing content specified by the profile associated with the user device comprises accessing the specified content in response to the user device being coupled to the network-enabled power charging device.

17. The method of claim 11, wherein accessing content specified by the profile associated with the user device comprises accessing the specified content in response to the user device not being coupled to the network-enabled power charging device.

18. The method of claim 11, wherein accessing content specified by the profile associated with the user device comprises accessing the specified content at regular intervals.

19. The method of claim 11, wherein accessing content specified by the profile associated with the user device comprises accessing the specified content based on detecting, by the network-enabled power charging device, that additional specified content is available.

20. The method of claim 11, wherein the operations further comprise:
determining, by the network-enabled power charging device, a device state associated with the network-enabled power charging device; and
outputting, by the network-enabled power charging device, an indication of the device state.
